(19) United States
(12) Patent Application Publication
(10) Pub. No.: US 2025/0377275 A1
(43) Pub. Date: Dec. 11, 2025

(54) MODULAR MECHANICAL TEST APPARATUS FOR CMC COMPONENT

(71) Applicants: Rolls-Royce High Temperature Composites, Inc., Cypress, CA (US); Rolls-Royce North American Technologies, Inc., Indianapolis, IN (US); Rolls-Royce plc, London (GB)

(72) Inventors: Kristopher Erlitz, Cypress, CA (US); Ronald Adolphus Bledsoe, Cypress, CA (US); Thomas Tran, Cypress, CA (US); Jason David Baker, Indianapolis, IN (US); Daniel Jozef Traudes, Cypress, CA (US); Stephen John Pattison, London (GB)

(21) Appl. No.: 18/737,303

(22) Filed: Jun. 7, 2024

(51) Int. Cl. G01N 3/08

(52) U.S. Cl. CPC G01N 3/08; G01N 2203/0019; G01N 2203/0032; G01N 2203/0087

(57) ABSTRACT

A test apparatus for a ceramic matrix composite (CMC) component. The test apparatus includes a first support member configured to mechanically support a CMC component from a first side. The CMC component includes a T-joint and a pinhole. The test apparatus includes a second support member configured to mechanically support the CMC component from a second side opposite the first side. The first support member and the second support member are configured to be forced toward each other to cause the CMC component to fail at the pinhole and not at the T-joint.

### TECHNICAL FIELD

The disclosure relates to mechanical test systems. More particularly, the disclosure relates to mechanical test systems for ceramic matrix composite components.

### BACKGROUND

Ceramic matrix composite (CMC) components may be well-suited for high-temperature mechanical (e.g., aerospace) applications because of their toughness, thermal resistance, high temperature strength, chemical stability, and light weight relative to components made from other materials. At least some portion of manufactured CMC components may need to be mechanically tested to determine various properties during quality inspection or validation.

### SUMMARY

Ceramic matrix composite (CMC) components are well-suited for high-temperature mechanical systems because of their toughness, thermal resistance, high temperature strength, chemical stability, and light weight relative to components made from other materials. For these reasons, CMC components may be used in high-temperature mechanical systems such as gas turbine engines. Some example applications include seal segments (e.g., high pressure seal segments), stiffeners, and other components.

CMC components include ceramic fibers embedded in a ceramic matrix. The ceramic fibers may be disordered (e.g., chopped) or may be woven in an orderly fashion. For example, ceramic fibers may be woven into two-dimensional sheets, commonly called plies, which may be formed (e.g., stacked) into a three-dimensional shape. The lay-up of fibrous sheets may be infiltrated with the ceramic matrix to form the component.

Certain types of CMC components may include a T-joint where an edge of an extra ligament is formed normal to a surface of a base of the component. Where the CMC component is formed of laminated plies, the plies may be curved and laminated together to form the T-joint. In specific examples, the CMC component may define an aperture near the T-joint. The aperture may be a pinhole for placement of a pin, a cooling hole configured to pass cooling fluid through the component, or the like. Although generally referred to herein as a pinhole, other functions and purposes of the apertures described herein are also considered.

It may be important to understand the mechanical properties of the CMC component to ensure safe operation of the high-temperature mechanical system. For example, where the CMC component is a part of a gas turbine engine, such as a high pressure seal segment, mechanical failure of the component during operation of the gas turbine engine may result in the part becoming dislodged and damaging other components of the engine. As such, it may be important to test and determine the load under which the CMC component will mechanically fail (e.g., deform or break apart). In examples where the CMC component includes a T-joint located near a pinhole, it may be necessary to measure and determine the force required to delaminate the plies of the T-joint and to measure and determine the force required to cause the CMC component to fail at the pinhole. Understanding the different failure modes of the component may be important to understand how the CMC component will perform during operation of an airplane or other high-temperature mechanical system of which the CMC component is a part.

It may be difficult to measure and determine the load under which the pinhole will fail because of the proximity of the pinhole to the T-joint. In some examples, the plies making up the T-joint may tend to delaminate before the pinhole fails. For example, certain techniques and associated test apparatus developed for pinhole testing may pull apart the CMC component at the T-joint before causing the pinhole to fail. When the failure mode during the test is the wrong one, it may be difficult or impossible to predict the performance of the pinhole of the CMC component during operation of the high-temperature mechanical system.

In accordance with one or more aspects of the present disclosure, a test apparatus for a CMC component includes a modular kit. The test apparatus includes support members which mechanically support a CMC component that includes a T-joint and a pinhole. The support members mechanically support the CMC component in a selectively tailored way such that, when tested under load, the CMC component fails at the pinhole and not at the T-joint. The support members may include a first support member configured to mechanically support a component from a first side and a second support member configured to mechanically support the CMC component from a second side opposite the first side. The first support member and the second support member may be configured to attach to a load cell such that, when the first support member and the second support member are forced toward each other by the load cell, the pinhole deforms or breaks apart rather than the T-joint delaminating. By determining the force required to cause the pinhole to fail, the disclosed test apparatus may allow for better understanding and evaluation of the CMC component in service.

In accordance with one or more examples of the present disclosure, a test apparatus for a ceramic matrix composite (CMC) component includes a first support member and a second support member. The first support member is configured to mechanically support a CMC component from a first side. The CMC component includes a T-joint and a pinhole. The second support member is configured to mechanically support the CMC component from a second side opposite the first side. The first support member and the second support member are configured to be forced toward each other to cause the CMC component to fail at the pinhole and not at the T-joint.

In accordance with one or more examples of the present disclosure, a technique includes forcing a first support member mechanically supporting a CMC component from a first side toward a second support member supporting the second CMC component from a second, opposite side. The CMC component includes a T-joint and a pinhole. The technique includes causing the CMC component to fail at the pinhole and not at the T-joint.

The details of one or more examples are set forth in the accompanying drawings and the description below. Other features, objects, and advantages will be apparent from the description and drawings, and from the claims.

### BRIEF DESCRIPTION OF DRAWINGS

FIGS. 1A and 1B are conceptual diagrams illustrating an example CMC component in accordance with one or more examples of the present disclosure. FIG. 1A illustrates the example CMC component from a perspective view. FIG. 1B illustrates a conceptual cross-sectional side view of the example CMC component of FIG. 1A.

FIG. 2 is a conceptual perspective view of an example CMC component which has failed at a pinhole, in accordance with one or more examples of the present disclosure.

FIG. 3A is a conceptual perspective view of an example CMC component which has failed at a T-joint. FIG. 3B illustrates a conceptual cross-sectional side view of the example CMC component of FIG. 3A.

FIGS. 4A-4D illustrate an example test apparatus in accordance with one or more examples of the present disclosure. FIG. 4A illustrates a conceptual perspective view of a test apparatus including a first support member and a second support member attached to a load cell and mechanically supporting a CMC component that includes a T-joint and a pinhole. FIG. 4B illustrate the first support member of FIG. 4A from a conceptual side view.

FIG. 4C illustrates the second support member of FIG. 4A from a conceptual side view. FIG. 4D illustrates the second support member of FIG. 4C from a conceptual top view.

FIG. 5 is a conceptual force diagram illustrating forces associated with the test apparatus of FIG. 4.

FIG. 6 is a conceptual diagram illustrating an example load cell and computing device, in accordance with one or more examples of the present disclosure.

FIG. 7 is a flow diagram illustrating a technique for testing a CMC component, according to one or more examples of the present disclosure.

FIGS. 8A-8C are photographs illustrating example CMC components which include a T-joint and a pinhole. The example CMC components were tested with a test apparatus according to the present disclosure. The example CMC components failed at the pinhole and not at the T-joint.

### DETAILED DESCRIPTION

The disclosure describes apparatus and techniques for mechanically testing a ceramic matrix composite (CMC) component. Ceramic matrix composite (CMC) components are well-suited for high-temperature mechanical systems because of their toughness, thermal resistance, high temperature strength, chemical stability, and light weight relative to components made from other materials. For these reasons, CMC components may be used in gas turbine engines. Some example applications for CMC components include seal segments (e.g., high pressure seal segments), stiffeners, and other components.

CMC components may include ceramic fibers embedded in a ceramic matrix. The ceramic fibers may be disordered (e.g., chopped) or may be woven in an orderly fashion. For example, ceramic fibers may be woven into two-dimensional sheets, commonly called plies, which may be formed (e.g., stacked) into a three-dimensional shape. The lay-up of fibrous sheets may be infiltrated with the ceramic matrix, and hardened to form the CMC component.

Certain types of CMC component may include a T-joint where an edge of an extra ligament is formed normal to a surface of a base of the component. Where the CMC component is formed of laminated plies, the plies may be curved and laminated together to form the T-joint. The CMC component may define an aperture near the T-joint. The aperture may be a pinhole for placement of a pin, a cooling hole configured to pass cooling fluid through the component, or the like. When intended as a structural component, the mechanical strength of the CMC component surrounding the pinhole must meet or exceed a certain threshold. The threshold may be specified or may be experimentally determined. At least some of the CMC components may be mechanically tested to compare the mechanical strength of the manufactured component to the threshold.

Mechanical testing to ensure that the mechanical strength of the CMC component meets a threshold may be important to ensure safe operation of the high-temperature mechanical system. For example, where the CMC component is a part of a gas turbine engine, such as a high pressure seal segment (HPSS), mechanical failure of the pinhole of the CMC component during operation of the gas turbine engine may result in the CMC component becoming dislodged and damaging other components of the engine. As such, it may be important to test and determine the load under which the CMC component will mechanically fail (e.g., deform or break apart). In examples where the CMC component includes a T-joint located near a pinhole, it may be necessary to measure and determine the force required to cause the CMC component to fail at the pinhole to measure and determine the mechanical force required to cause one failure mode. It may also be desirable to measure and determine the force required to cause the plies of the CMC component to delaminate to determine the mechanical force required to cause another failure mode. As such, it may be necessary to develop test apparatus and techniques designed to measure and determine to cause the first failure mode, where the pinhole fails, and to develop test apparatus and techniques designed to measure and determine the second failure mode, where the T-joint fails.

It may be difficult to measure and determine the load under which the pinhole will fail in CMC components where a pinhole is located near a T-joint. Since the plies making up the T-joint may tend to delaminate under a lower load than the load that is necessary to cause the pinhole to fail, certain test apparatus and techniques may cause the delamination failure mode rather than the pinhole failure mode. For example, certain techniques and associated test apparatus developed for pinhole testing may pull apart the CMC component at the T-joint before causing the pinhole to fail. When the failure mode during the mechanical test is the wrong one, it may be difficult or impossible to predict the performance of the pinhole of the CMC component during operation of the high-temperature mechanical system.

In accordance with one or more examples of the present disclosure, a test apparatus for a CMC component includes a modular kit. The test apparatus includes support members which mechanically support a CMC component that includes a T-joint and a pinhole. The support members mechanically support the CMC component in a selectively tailored way such that, when tested under load, the CMC component fails at the pinhole and not at the T-joint. The support members may include a first support member configured to mechanically support a component from a first side and a second support member configured to mechanically support the CMC component from a second side opposite the first side. The first support member and the second support member may be configured to attach to a load cell such that, when the first support member and the second support member are forced toward each other by the load cell, the pinhole deforms or breaks apart rather than the T-joint delaminating. By determining the force required to cause the pinhole to fail, the disclosed test apparatus may allow for measuring and determining the mechanical strength of the CMC component surrounding the pinhole. Such information may allow for better understanding and evaluation of the CMC component in service.

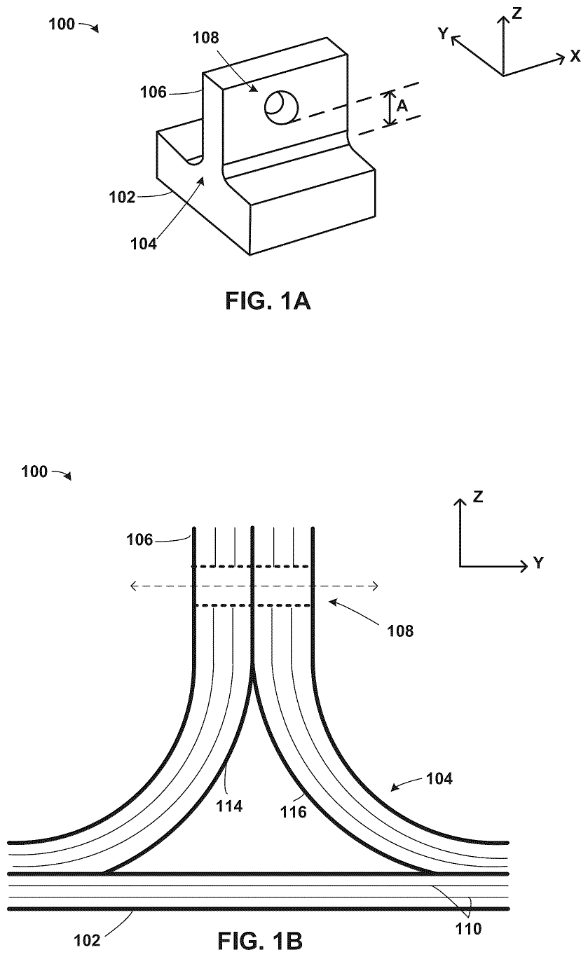

FIGS. 1A and 1B are conceptual diagrams illustrating CMC component 100. CMC component 100 may include ceramic fibers embedded in a ceramic matrix. The ceramic material of the ceramic fibers and/or the ceramic matrix may include any useful ceramic material, including, for example, silicon carbide, silicon nitride, alumina, silica, and the like. The ceramic fibers may include a continuous reinforcement or a discontinuous reinforcement. For example, the ceramic fibers may include discontinuous whiskers, platelets, or particulates. In some examples, the ceramic fibers may include a continuous monofilament or multifilament weave.

In some embodiments, the filler composition may be the same as the ceramic matrix material. For example, a silicon carbide matrix may surround silicon carbide fibers. In other embodiments, the filler material may include a different composition than the ceramic matrix, such as mullite fibers in an alumina matrix, or the like. In one example, CMC component 100 includes silicon carbide continuous fibers embedded in a silicon carbide matrix.

The fibers of CMC component 100 may be disordered (e.g., chopped) or may be woven in an orderly fashion. For example, ceramic fibers may be woven into two-dimensional sheets, which may be called plies 110. Plies 110 may be formed (e.g., stacked) into a three-dimensional shape. The lay-up of plies 110 may be infiltrated with the ceramic matrix to form component 100.

CMC component 100 includes base 102 and ligament 106. Ligament 106 is joined to base 102 by T-joint 104. As illustrated, CMC component 100 may be a portion of a larger component, such as a cut-out portion of a high pressure seal segment or other component of a gas turbine engine.

In the illustrated example, ligament 106 protrudes from base 102 at an angle normal from the surface of base 102, although other angles are also considered. Component 100 defines pinhole 108 near T-joint 104. Pinhole 108 may be configured to receive a pin or other structural element, for example to mechanically attach CMC component 100 to other portions of the high temperature mechanical system. As such, it may be important to determine the mechanical strength of ligament 106 surrounding pinhole 108 to determine the load under which component 100 will fail during operation. Although pinhole 108 is circular in the illustrated example, in other examples pinhole 108 may define any other suitable shape or combination of shapes, including elliptical, rectangular, or the like.

As mentioned, plies 110 may be stacked and laminated into a ceramic matrix to form and shape base 102. To form ligament 106, plies 114, 116 may be positioned on part of the same layer, and may be curved or folded away (e.g., in a normal direction) from the surface of base 102, then laminated to base 102 and to each other to form ligament 106. Additional plies may be added to build base 102 and/or ligament 106 to the desired dimensions. The joint region between ligament 106 and base 102 may be called T-joint 104.

CMC component 100 may define pinhole 108 near T-joint 104. Pinhole 108 may be considered near T-joint 104 when application of a load to a pin placed through pinhole 108 causes delamination plies 110 at T-joint rather than failure of ligament 106. For example, a nearest point (e.g., bottom edge) of pinhole 108 may be displaced from a surface of base 102 by a distance A. Pinhole 108 may be located near T-joint 104 when distance A is less than about 10 centimeters (cm), such as about 5 cm, or about 3 cm, or about 1 cm. The term “about” as used herein, may include the stated value plus or minus 10 percent of the stated value.

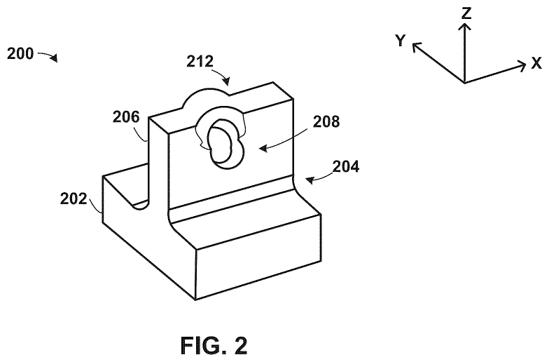

FIG. 2 is a conceptual perspective view of CMC component 200. CMC component 200 may be an example of CMC component 100 of FIG. 1, except where differing as described below. Similar reference numerals indicate similar elements. CMC component 200 has been mechanically tested and failed at pinhole 208, as illustrated by the cracks 212 and deformation of pinhole 108 relative to FIG. 1. The illustrated failure mode of FIG. 2 may be desirable, because the mechanical strength of ligament 206 surrounding pinhole 108 may be measured by application of a load until the illustrated failure mode is achieved, and a computer and load cell may sense the load that was applied to break component 200 in the illustrated way to determine the mechanical strength of ligament 206 and compare the mechanical strength to a threshold mechanical strength.

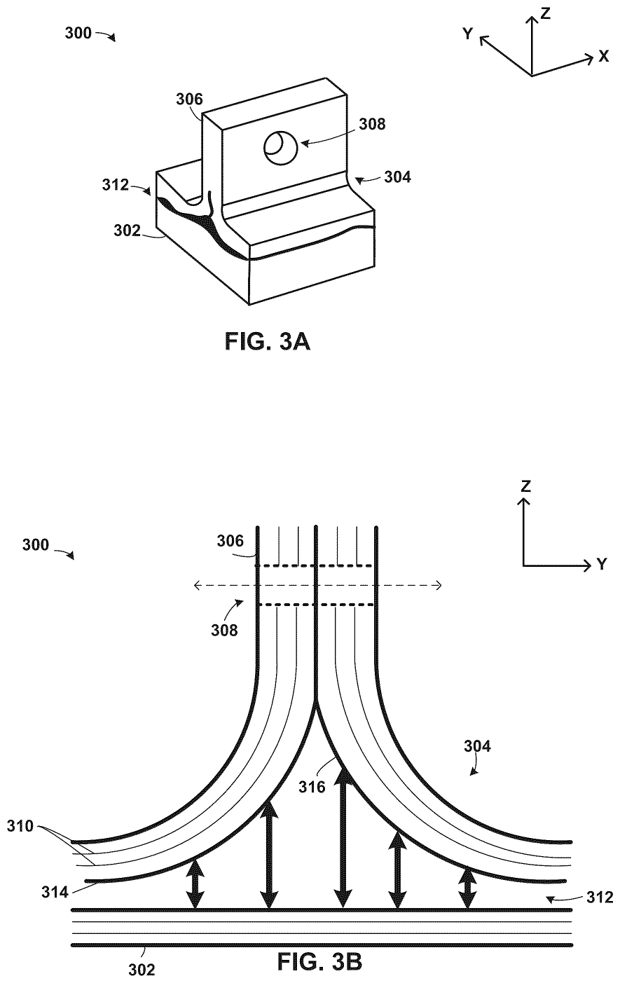

FIG. 3A is a conceptual perspective view of CMC component 300. FIG. 3B is a cross-sectional side view of example component 300. CMC component 300 may be an example of CMC component 100 of FIG. 1, except where differing as described below. Similar reference numerals indicate similar elements. CMC component 300 has been mechanically tested and failed by delamination at T-joint 304, as illustrated by the cracks 312 and deformation of component 300 relative to FIG. 1. With reference to FIG. 3B, plies 314, 316 are illustrated as delaminating from base 302 by the vertical arrows. Other plies or combinations of plies of plies 310 may delaminate during a delamination failure. The illustrated failure mode of FIGS. 3A-3B may be undesirable, because the mechanical strength of ligament 306 surrounding pinhole 308 may not be measured and thus the mechanical strength of ligament 306 surrounding pinhole 308 may not be determined, because CMC component 300 failed by delamination of T-joint 304 before failing at pinhole 308. As discussed above, the failure mode illustrated in FIG. 2, where the CMC component mechanically fails at the pinhole, may be desirable over the failure mode of FIGS. 3A-3B, where the CMC component mechanically fails by delamination of plies at the T-joint.

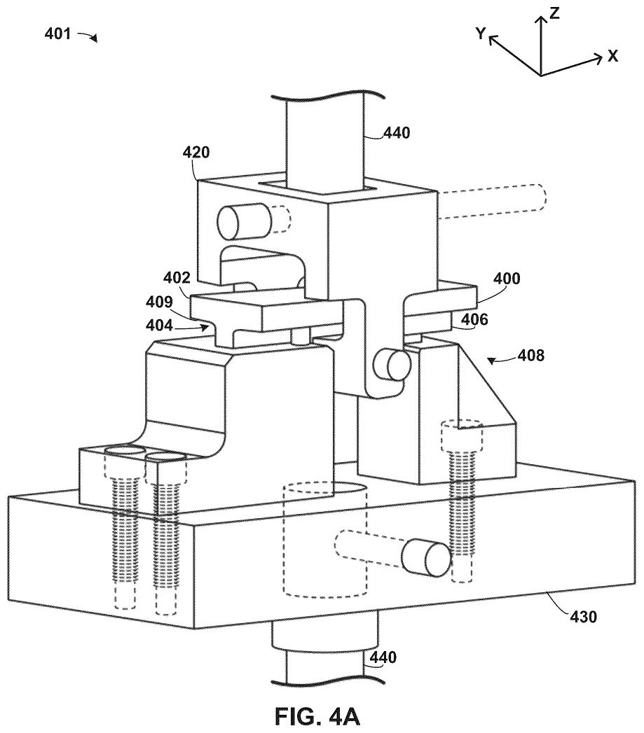

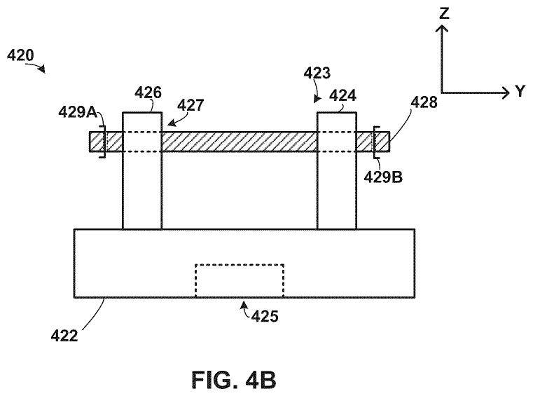

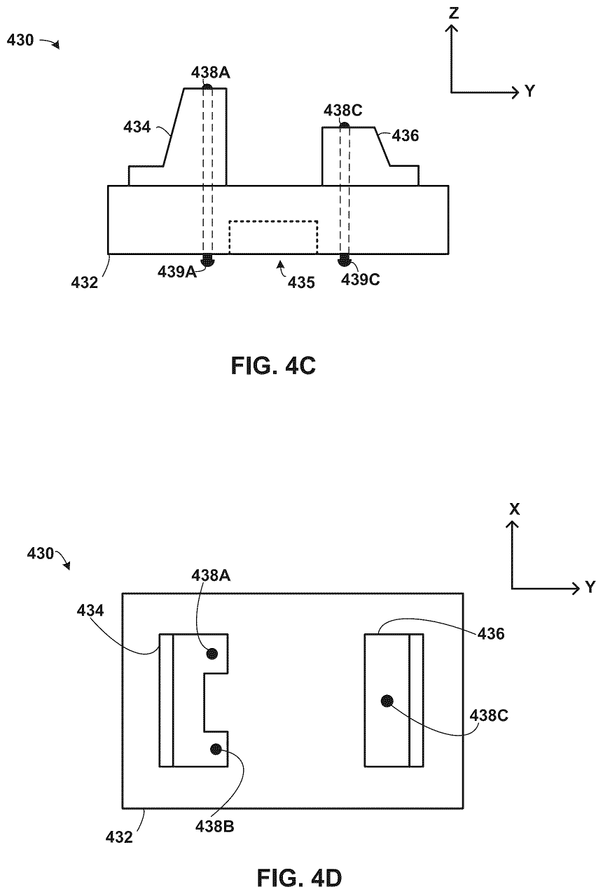

Certain test apparatus and techniques exist for mechanically testing CMC components that include a pinhole. These apparatus are utilized for tests of panel-based (e.g., flat and plate-like specimens with a pinhole at one or both ends of the plate). To test CMC components that include a pinhole disposed near a T-joint, these certain apparatus and techniques may be modified by clamping the base of the component to a load cell. These certain techniques may further include passing a pin through the pinhole, and pulling the pin away from the base, the base away from the pin, or both. In these and other techniques, the undesired failure mode of FIGS. 3A-3B may be achieved, because the force required to delaminate the T-joint is lesser in magnitude than the force required to break the ligament surrounding the pinhole by pulling on the pin when the load is applied in this way. For example, using such apparatus and techniques, the failure mode of FIGS. 3A-3B may be reached under a load of less than about 30 kilonewtons (kN) (about 6,744 lbf), such as less than about 28.8 kilonewtons (about 6,500 lbf). In such examples, the failure mode of FIG. 2 may not be reached until the load applied is greater than about 30 kilonewtons, such as greater than about 33 kilonewtons. As such, these apparatus and techniques may not be capable of determining the mechanical strength of the CMC component surrounding the pinhole. Unlike these certain test apparatus and techniques, apparatus and techniques of the present disclosure may be capable of causing a CMC component to break according to the desirable failure mode illustrated in FIG. 2, and not the failure mode illustrated in FIGS. 3A-3B. A test apparatus in accordance with the present disclosure is illustrated in FIGS. 4A-4D.

FIGS. 4A-4D illustrate test apparatus 401. FIG. 4A illustrates a conceptual perspective view of test apparatus 401, which includes first support member 420 and second support member 430 attached to load cell 440, of which only a small portion is shown. First support member mechanically supports CMC component 400. CMC component 400 may be an example of CMC component 100 of FIGS. 1A-1B. As such, CMC component 400 includes pinhole 408 on ligament 406 disposed near T-joint 404 which joins ligament 406 to base 402.

First support member 420 mechanically supports CMC component 400 from a first side (e.g., a top side or a left side). Second support member 430 mechanically supports CMC component 400 from a second side opposite the first side (e.g., a bottom side or a right side). To mechanically test CMC component 400, load cell 440 applies a force (e.g., a downward force) to first support member 420 and/or a force to second support member 430 (e.g., an upward force). In this way, first support member 420 and second support member 430 are forced toward each other at increasing load until CMC component 400 fails at pinhole 408 (FIG. 2) and not at T-joint 404 (FIGS. 3A-3B).

FIG. 4B illustrates the first support member 420 of FIG. 4A from a conceptual side view. Broken lines indicate hidden features. First support member includes base 422 that defines cavity 425 configured to be attached to load cell 440. Cavity 425 may be a threaded cavity configured to receive a threaded connection. Other ways to attach first support member 420 to load cell 440 are also considered. First support member 420 may include claw 423 selectively tailored to fit around ligament 406 of CMC component 400. Claw 423 may protrude a distance far enough from base 422 to reach pinhole 408.

Claw 423 may define arms 424, 426. Arms 424, 426 may define through-hole 427 configured to receive slip-fit pin 428. To mechanically support CMC component 400, claw 423 may be positioned over ligament 406 of CMC component 400 such that through-hole 427 aligns with pinhole 408 of CMC component 400. Slip-fit pin 428 may pass through arms 424, 426 of claw 423 and through pinhole 408 defined by CMC component 400. Slip-fit pin 428 may be locked in place during loading of test apparatus 401 by one or more clips 429A, 429B. Clips 429A, 429B may be a locking pin, spring snap, carabiner, or the like.

In some examples, first support member 420 may be designed such that slip-fit pin 428 is the only part first support member 420 configured to contact CMC component 400. Load cell 440 may apply a force to first support member 420 such that slip-fit pin 428 applies a force in a direction that is normal to surface plane 409 of base 402 of CMC component 400.

First support member 420 may be made from any suitable material to withstand forces necessary to cause CMC component 400 to fail rather than support member 420. For example, base 422 and claw 423 may include one or more metal alloys. The metal alloys may include PH 17-4 Steel, Inconel 718 Steel, a CMSX-4 nickel-based superalloy material, or another superalloy material. Slip-fit pin 428 may include one or more of a metal alloy or a ceramic. For example, slip-fit pin 428 may include D2 tool steel, PH 17-4 Steel, tungsten carbide, silicon nitride, MAR-M 247 nickel-based superalloy, or another suitable superalloy or ceramic material.

FIG. 4C illustrates the second support member 430 of FIG. 4A from a conceptual side view. FIG. 4D illustrates the second support member of FIG. 4C from a conceptual top view. Second support member includes base 432 that defines cavity 435 configured to be attached to load cell 440. Cavity 435 may be a threaded cavity configured to receive a threaded connection. Other ways to attach second support member 430 to load cell 440 are also considered.

Second support member 430 may include a plurality of point contacts 438A, 438B, 438C (collectively “point contacts 438”) configured to contact CMC component 400. Point contacts 438 may protrude from second support member 430. Inclusion of point contacts 438 may assist in controlling the way force applied to first support member 420 and/or second support member 430 is transferred to CMC component 400 by controlling the location of forces applied to CMC component 400. Point contacts 438 may be selectively located at points of the most structural strength on CMC component 400, and/or may be selectively located at points where the stresses applied to T-joint 404 is reduced or minimized relative to other locations. In this way, inclusion of point contacts 438 may ensure that the desired failure mode of FIG. 2 is achieved when CMC component 400 is tested by test apparatus 401.

In some examples, at least one of point contacts 438 are position-adjustable. For example, point contact 438A may be position-adjustable by being mounted on set screw 439A. In some examples, each point contact of points 438 may be position-adjustable by a corresponding set screw of set screws 439. Although only illustrated as being position-adjustable in the Z-direction, in some examples point contacts 438 may be position-adjustable in each of the X, Y, and Z-directions. Inclusion of position-adjustable point contacts may ensure proper force transfer during mechanical testing to CMC component 400 and for the ability to adjust test apparatus 401 to account for different types of CMC components, different cut-out portions of CMC components, and/81 or dimensional variability between the same types of CMC components.

In some examples, as illustrated, the plurality of point contacts may include exactly three point contacts 438A, 438B, 438C. Inclusion of exactly three point contacts 438 may provide adequate mechanical support of CMC component during the applied load without biasing the force applied by load cell. Inclusion of only two point contact 438 may allow for CMC component to slip out of position under the applied load, which may cause a failed test. Inclusion of more than three point contacts 438, such as four point contacts 438, may be equally undesirable in some examples, because four point contacts 438 may bias the force applied to CMC component 400 and/or introduce undesired stresses in CMC component 400.

In some examples, second support member 420 may include first arm 434 and second arm 436. First arm 434 and second arm 436 may be displaced from each other to allow claw 423 and CMC component 400 to fit between. In some examples, as illustrated, first point contact 438A and second point contact 438B may be disposed on first arm 434, and third-point contact 438C may be disposed on second arm 436. In this way, point contacts 438 may be displaced from each other such that CMC component 400 is properly supported during mechanical testing, without biasing the force. Test apparatus 401 may cause CMC component to fail at pinhole 408 and not at T-joint 404.

In some examples, at least one of first point contact 438A, second point 438B, or third point contact 438C comprises a dome shape, as illustrated. In more specific examples, each of first point contact 438A, 438B, and 438C may define a dome (e.g., hemispherical) shape. The domed shape of one or more point contact 438 may allow for the surface area of contact between CMC component 400 and the point contact 438 when increasing force is applied. The increasing surface area may reduce local stresses introduced into CMC component 400, and may thereby allow for test apparatus 401 to cause CMC component 400 to fail at pinhole 408 and not at T-joint 404 or another location.

First support member 420 may be made from any suitable material to withstand forces necessary to cause CMC component 400 to fail rather than support member 420. For example, base 422 and claw 423 may include one or more metal alloys. The metal alloys may include PH 17-4 Steel, Inconel 718 Steel, a CMSX-4 nickel-based superalloy material, or another superalloy material.

Point contacts 438 may be rigid, and may be made of the same or a different material as the other components of second support member 430. In some examples, at least one of first point contact 438A, second point contact 438B, or third point contact 438C may include a deformable material configured to yield under a load that is less than the load required to cause CMC component 400 to fail at pinhole 408. In this way, the materials of point contacts 438 may allow for the surface area of contact between CMC component 400 and the point contact 438 when increasing force is applied. The increasing surface area may reduce local stresses introduced into CMC component 400, and may thereby allow for test apparatus 401 to cause CMC component 400 to fail at pinhole 408 and not at T-joint 404 or another location. In one specific example, the inventors have found that forming first point contact 438A and second point contact 438B from a deformable material and third point contact 438C from a rigid material may promote the desired failure mode of FIG. 2 and not the undesired failure mode of FIGS. 3A-3B. Suitable materials for first point contact 438A and second point contact 438B may include metal alloys and ceramics. For example, aluminum alloy 6061-T6, 410 stainless steel, PH 17-4 steel, 304 stainless steel, silicon nitride, or another superalloy or ceramic material may be used to form first point contact 438A and/or second point contact 438C. Suitable materials for third point contact 438C may include silicon nitride, PH 17-4 steel, 52100 steel alloy, or another metallic or ceramic material.

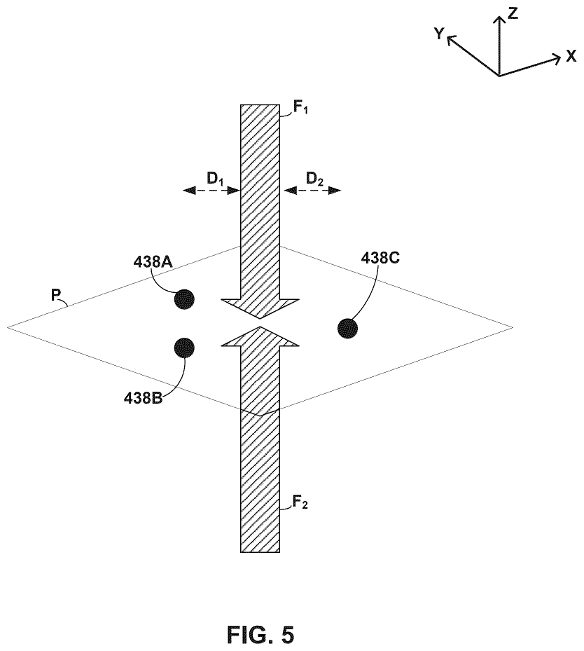

FIG. 5 is a conceptual force diagram illustrating forces associated with test apparatus 401 of FIG. 4. Load cell 440 may apply force vector F₁ to first support member 420 and force vector F₂ to second support member 430 to force first support member 420 and second support member 430 toward each other to cause CMC component 400 to fail at pinhole 408 and not at T-joint 404. In some examples, force vector F₁ and F₂ may be collinear. Point contacts 438 may occupy spatial positions such that the point contacts define plane P. Plane P may, in some examples, be defined orthogonal to force vector F₁.

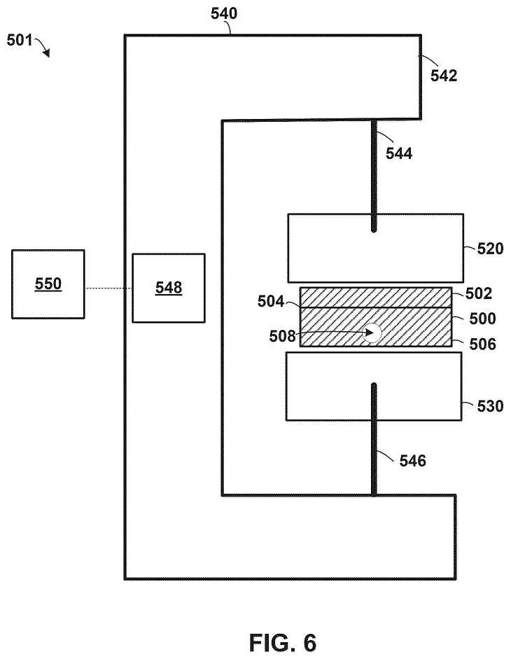

FIG. 6 is a conceptual diagram illustrating example test apparatus 501. Test apparatus 501 may be an example of test apparatus 401 of FIGS. 4A-4D, where similar reference numerals indicate similar elements. Test apparatus 501 includes load cell 540, computing device 550, and a modular testing kit including first support member 520 and second support member 530, in accordance with one or more examples of the present disclosure.

Load cell 540 includes frame 542, from which first loading member 544 and second loading member 546 may extend. First loading member 544 attaches to first support member 520 while second loading member 546 attaches to second support member 530. Computing device 550 may cause load cell 540 to apply force vector F₁ (FIG. 5) to first support member 520 through loading member 544 at increasing load. Similarly, computing device 550 may cause load cell 540 to apply force vector F₂ (FIG. 5) at increasing load to second support member 530 through second loading member 546. First support member 520 mechanically supports CMC component 500 from a first side and second support member 530 mechanically supports CMC component 500 from a second side opposite the first side. Computing device 550 may cause the force vectors F₁, F₂ to increase in magnitude until CMC component 500 mechanically fails.

Load cell 540 may further include sensing system 548 electrically coupled to computing device 550. Sensing system 548 may include one or more sensors configured to sense the load at which CMC component 500 mechanically fails. Computing device 550 may tag and record the load, and may further associate the tag with CMC component 500.

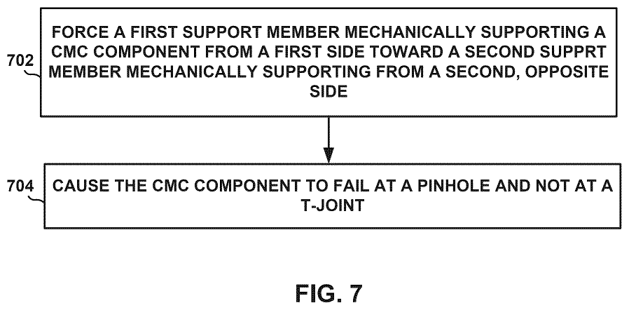

FIG. 7 is a flow diagram illustrating a technique for testing a CMC component, according to one or more examples of the present disclosure. The technique of FIG. 7 may be employed by test apparatus 401 of FIGS. 4A-5, test apparatus 501, or test apparatus 501 of FIG. 6. The illustrated technique may be performed on CMC component 100 of FIGS. 1A-1B to achieve the pinhole failure mode of FIG. 2 and not the T-joint failure mode of FIGS. 3A-3B. The illustrated technique may be performed on other CMC components using other test apparatus, and the described CMC components may be mechanically tested according to other techniques.

With concurrent reference to FIG. 6, computing device 550 may cause load cell 540 to apply a force through first loading member 544 to force first support member 520 toward second support member 530 (702). Simultaneously, in some examples, computing device 550 may cause load cell 540 to apply a force through second loading member 546 to second support member 530 to force second support member 530 toward first support member 520. CMC component 500 may be positioned between and mechanically supported by first support member 520 and second support member 530. CMC component 500 includes T-joint 504 and pinhole 508. The force applied to first support member 520 and/or second support member 530 by load cell 540 may cause CMC component 500 to mechanically fail at pinhole 508 and not at T-joint 504.

### EXAMPLES

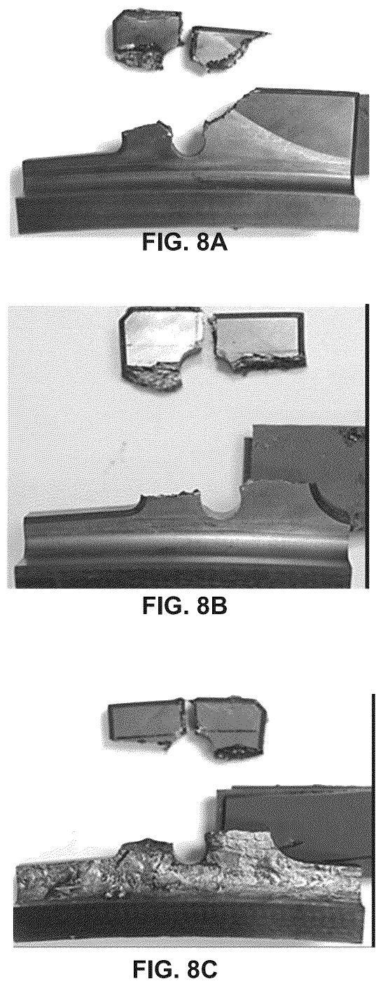

FIGS. 8A-8C are photographs illustrating example CMC components which include a T-joint and a pinhole. The example CMC components were tested with a test apparatus according to the present disclosure. The example CMC components failed at the pinhole and not at the T-joint.

The techniques described in this disclosure may also be embodied or encoded in an article of manufacture including a computer-readable storage medium encoded with instructions. Instructions embedded or encoded in an article of manufacture including a computer-readable storage medium encoded, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

Various examples have been described. These and other examples are within the scope of the following examples and claims.

Example 1: A test apparatus for a ceramic matrix composite (CMC) component, the test apparatus includes a first support member configured to mechanically support a CMC component from a first side, the CMC component comprising a T-joint and a pinhole; and a second support member configured to mechanically support the CMC component from a second side opposite the first side, wherein the first support member and the second support member are configured to be forced toward each other to cause the CMC component to fail at the pinhole and not at the T-joint.

Example 2: The test apparatus of example 1, wherein the first support member includes a slip-fit pin configured to pass through the pinhole.

Example 3: The test apparatus of example 2, wherein the slip-fit pin is the only part of the first support member configured to contact the CMC component.

Example 4: The test apparatus of example 3, wherein the slip-fit pin is configured to apply a force in a direction that is normal to a surface plane of a base of the CMC component.

Example 5: The test apparatus of any of examples 1 through 4, wherein the second support member comprises a plurality of point contacts configured to contact the CMC component.

Example 6: The test apparatus of example 5, wherein at least one of the plurality of point contacts is position-adjustable.

Example 7: The test apparatus of any of examples 5 and 6, wherein the plurality of point contacts is exactly three point contacts comprising a first point contact, a second point contact, and a third point contact.

Example 8: The test apparatus of example 7, wherein the first point contact and the second point contact are displaced from the third point contact in a plane orthogonal to a force vector applied to the first support member.

Example 9: The test apparatus of any of examples 7 and 8, wherein the second support member comprises a first arm and a second arm, wherein: the first point contact and the second point contact are disposed on the first arm, and the third point contact is disposed on the second arm.

Example 10: The test apparatus of any of examples 7 through 9, wherein at least one of the first point contact, the second point, or the third point contact comprise a dome shape configured to increase a surface area of contact between the CMC component and the point contact when increasing force is applied to cause the CMC component to fail at the pinhole.

Example 11: The test apparatus of example 10, wherein at least one of the first point contact, the second point contact, or the third point contact comprise a material configured to yield under a load that is less than the load required to cause the CMC component to fail at the pinhole.

Example 12: The test apparatus of any of examples 1 through 11, further comprising the CMC component, wherein the CMC component is a gas turbine engine component or a portion of a gas turbine engine component.

Example 13: The apparatus of example 12, wherein the CMC component is a high pressure seal segment or a portion of a high pressure seal segment.

Example 14: The apparatus of any of examples 12 and 13, wherein the T-joint and the pinhole are located near each other.

Example 15: The apparatus of any of examples 12 through 14, wherein the T-joint and the pinhole are located within about 5 centimeters.

Example 16: The apparatus of any of examples 12 through 15, wherein the CMC component is formed from a plurality of two-dimensional plies.

Example 17: The apparatus of any of examples 1 through 16, further comprising a load cell configured to force the first support member and the second support member toward each other.

Example 18: The apparatus of example 17, further comprising a computing device configured to control the force applied to the first support member and the second support member.

Example 19: The apparatus of example 18, wherein the computing device is configured to capture the force at which the pinhole fails.

Example 20: A method for testing a ceramic matrix composite (CMC) component includes forcing a first support member mechanically supporting a CMC component from a first side toward a second support member supporting the CMC component from a second, opposite side, wherein the CMC component comprising a T-joint and a pinhole; and causing the CMC component to fail at the pinhole and not at the T-joint.

What is claimed is:

1. A test apparatus for a ceramic matrix composite (CMC) component, the test apparatus comprising:
a first support member configured to mechanically support a CMC component from a first side, the CMC component comprising a T-joint and a pinhole; and
a second support member configured to mechanically support the CMC component from a second side opposite the first side,
wherein the first support member and the second support member are configured to be forced toward each other to cause the CMC component to fail at the pinhole and not at the T-joint.

2. The test apparatus of claim 1, wherein the first support member includes a slip-fit pin configured to pass through the pinhole.

3. The test apparatus of claim 2, wherein the slip-fit pin is the only part of the first support member configured to contact the CMC component.

4. The test apparatus of claim 3, wherein the slip-fit pin is configured to apply a force in a direction that is normal to a surface plane of a base of the CMC component.

5. The test apparatus of claim 1, wherein the second support member comprises a plurality of point contacts configured to contact the CMC component.

6. The test apparatus of claim 5, wherein at least one of the plurality of point contacts is position-adjustable.

7. The test apparatus of claim 5, wherein the plurality of point contacts is exactly three point contacts comprising a first point contact, a second point contact, and a third point contact.

8. The test apparatus of claim 7, wherein the first point contact and the second point contact are displaced from the third point contact in a plane orthogonal to a force vector applied to the first support member.

9. The test apparatus of claim 7, wherein the second support member comprises a first arm and a second arm, wherein:
the first point contact and the second point contact are disposed on the first arm, and
the third point contact is disposed on the second arm.

10. The test apparatus of claim 7, wherein at least one of the first point contact, the second point, or the third point contact comprise a dome shape configured to increase a surface area of contact between the CMC component and the point contact when increasing force is applied to cause the CMC component to fail at the pinhole.

11. The test apparatus of claim 10, wherein at least one of the first point contact, the second point contact, or the third point contact comprise a material configured to yield under a load that is less than the load required to cause the CMC component to fail at the pinhole.

12. The test apparatus of claim 1, further comprising the CMC component, wherein the CMC component is a gas turbine engine component or a portion of a gas turbine engine component.

13. The apparatus of claim 12, wherein the CMC component is a high pressure seal segment or a portion of a high pressure seal segment.

14. The apparatus of claim 12, wherein the T-joint and the pinhole are located near each other.

15. The apparatus of claim 12, wherein the T-joint and the pinhole are located within about 5 centimeters.

16. The apparatus of claim 12, wherein the CMC component is formed from a plurality of two-dimensional plies.

17. The apparatus of claim 1, further comprising a load cell configured to force the first support member and the second support member toward each other.

18. The apparatus of claim 17, further comprising a computing device configured to control the force applied to the first support member and the second support member.

19. The apparatus of claim 18, wherein the computing device is configured to capture the force at which the pinhole fails.

20. A method for testing a ceramic matrix composite (CMC) component, the method comprising:
forcing a first support member mechanically supporting a CMC component from a first side toward a second support member supporting the CMC component from a second, opposite side, wherein the CMC component comprising a T-joint and a pinhole; and
causing the CMC component to fail at the pinhole and not at the T-joint.
